(19) United States
(12) Patent Application Publication
(10) Pub. No.: US 2004/0090642 A1
(43) Pub. Date: May 13, 2004

(54) Commodity information printing apparatus and commodity label attachment

(76) Inventor: Michiyasu Hikita, Shiga (JP)

Correspondence Address: Shiniyu Global IP Counselors, Suite 700, 1233 Twentieth Street NW, Washington, DC, 20036, US

(21) Appl. No.: 10/471,205

(22) PCT Filed: Sep. 13, 2002
(86) PCT No.: PCT/JP02/09476

(30) Foreign Application Priority Data
Dec. 20, 2001 (JP) 2001-387560

(51) Int. Cl. G06K 15/02; G06K 19/06; G06K 3/00

(52) U.S. Cl. 358/1.11; 358/1.18; 235/494

(57) ABSTRACT

The present invention provides 1) a label on which merchandise information is printed in a manner such that the merchandise information can be recognized promptly and accurately even in cases where a barcode cannot be properly read, and 2) a printing apparatus therefor. When a label L3, which includes a barcode, is printed, of the characters in a character string that represents the information contained in the barcode, only those characters belonging to a substantive character string S31, which corresponds to substantive merchandise information, are printed underlined. Alternatively, such characters are printed in reverse printing or outlined in a box. Thus in cases where an operator must refer to the substantive character string and make manual input using a ten-key pad, the substantive character string S31 is easy to recognize visually, meaning that input errors are avoided.

### FIELD OF INVENTION

The present invention relates to art for the printing of merchandise information as barcodes and character strings on merchandise packaging or merchandise attachments such as labels and tags.

### BACKGROUND TECHNOLOGY

It is well known that barcodes consist of multiple lines (bars) having a variety of widths, that are arranged according to a set of rules. Bar width, the combination of bars with differing widths, and the combination of bar width and the width of the space between bars are defined as fixed representations of numerical characters and the like so that each digit or alphabetic character is uniquely represented. This allows character string information comprising digits and the like to be expressed as barcodes. A character strings expressed as a barcode is read (i.e., decoded) by a reading device (i.e., scanner), so that the original character string is deciphered.

Barcodes have such advantages as allowing the instantaneous reading of information corresponding to a long character string (usually between 8 and 18 digits) and being suitable for mass printing; thus barcodes are widely used, particularly in the distribution sector, as an inexpensive and reliable method for automatic recognition of merchandise information. In the distribution sector, a variety of barcode types are used, depending upon such factors as distribution stage and type of merchandise, or depending on how merchandise is to be marketed.

FIG. 10 is an illustration showing an example of a typical barcode representation method. FIG. 10(a) shows barcode B101, a barcode in the PLU (price look up) style. The PLU barcode B101 is a type of barcode that is primarily printed by manufacturers on the packaging and the like for mass-produced merchandise; that is, it is a barcode used for what is called source marking. The PLU barcode B101 has a flag 101a for identifying country of origin, a manufacturer code 101b for identifying manufacturer, a merchandise code 101c for identifying merchandise, and a check digit 101d for checking whether or not there has been an error in the reading by a scanner. In FIG. 10(a), directly beneath the bars, a character string 101e is printed having the same information as the respective bars above.

The PLU barcode B101 does not include price information; thus it is mainly used for merchandise that is mass-produced at a plant or the like and, at least within a single store, will be sold at the same price. When such merchandise is marketed, the PLU barcode B101 printed on packaging and the like is read by a scanner at a cash resister, upon which price information for that particular merchandise is sent to the cash register by that store's POS system or the like; together with the information read by the scanner, the price information pertaining to the sale is stored on a memory device or the like in the cash register.

FIG. 10(b), meanwhile, shows a NON-PLU (non-price look up) barcode B102. This NON-PLU barcode B102 is mainly printed on labels and the like to be attached to merchandise for which merchandise price is determined by unit, such as weight or volume, with the sale price of individual pieces of merchandise differing according to volume; that is, this is a type of barcode for what is called in-store marking. While the external appearance of the NON-PLU barcode B102 may be no different from that of the PLU barcode B101, the constituent elements thereof are different; it has a flag 102a for identifying such matters as type of merchandise and sales location within a store, a merchandise code 102b for identifying the merchandise, a price code 102c representing the price of the merchandise, and a check digit 102d. In this FIG. 10(b), too, directly beneath the bars, a character string 102e is printed showing the same information as the respective bars above.

When merchandise having a NON-PLU barcode B102 is sold, price information is read directly from that barcode and is stored in the storage device or the like of a cash register as merchandise information pertaining to the sale.

When the barcode on the merchandise packaging or label or the like is read by a scanner at the cash register, if, for example, the packaging or label portion on which the barcode is printed is not flat, or if the barcode has been discolored, or if the scanner is not operating properly, a reading error may arise. When this happens, the information contained in the barcode must be inputted into the cash register by some other means. Usually, the operator of the cash register (the checker) uses the numerical keys of the register to key in the character string printed directly below the barcode. In such cases, what a checker must input is, for the PLU barcode B101, that portion of the character string 101e that corresponds to the manufacturer code 101b and the merchandise code 101c; for the NON-PLU barcode B102, that portion of the character string 102e that corresponds to the merchandise code 102b and the price code 102c showing the price of the merchandise.

However, as can be seen from FIG. 10, because the character strings corresponding to these portions are located in the central portions of the character string 101e and the character string 102e, there will often be input errors, as a checker is expected to work quickly, and in his or her hurry will input the wrong numbers.

Particularly in cases of merchandise having the NON-PLU barcode B102 attached, information relating to the sale price of individual pieces of merchandise is available only from the merchandise packaging or label or the like, and is difficult for a checker to acquire quickly by other means.

### DISCLOSURE OF THE INVENTION

The present invention was conceived in light of the above-described problems; its object is to present merchandise attachments such as labels that are printed in such a manner that merchandise information can be recognized promptly and accurately even when a barcode cannot be properly read, as well as a printing apparatus therefor.

In order to provide a solution to the above-described problems, the invention according to claim 1 is an apparatus for printing a barcode having a merchandise information code and an additional code, as well as a character string corresponding to the information contained in the barcode, on a print medium such as merchandise packaging or label or tag. This apparatus is characterized by being able to print the character string's substantive character string portion, which corresponds to the merchandise information code, and the character string's additional character string portion, which corresponds to the additional code, in different print formats. The merchandise information code corresponds to substantive merchandise information. The additional code does not contain such substantive merchandise information.

The invention of claim 2 is the apparatus according to claim 1, characterized by the fact that the different print formats include at least one of the following differences: 1) difference in character size; 2) difference in character font; 3) difference in whether the characters are enhanced or not; 4) difference in the type of enhancement on enhanced characters; and 5) difference in character color.

The invention of claim 3 is the apparatus according to either claim 1 or claim 2, characterized by the fact that printing using such differing print formats heightens the visible recognizability of the substantive character string over the visible recognizability of the additional character string.

The invention of claim 4 is an apparatus for printing a barcode having a merchandise information code and an additional code, as well as a character string corresponding to the information contained in such barcode, on such a print medium as merchandise packaging, label or tag, said apparatus characterized by the fact that the character string's substantive character string portion, which corresponds to the merchandise information code, is printed on a layout line different from the character string's additional character string portion, which corresponds to the additional code. The merchandise information code corresponds to substantive merchandise information. The additional code does not include such substantive merchandise information.

The invention of claim 5 is the apparatus according to claim 4, characterized by the fact that the substantive character string is printed on a line adjacent to such barcode, and the additional character string is printed on a layout line different from such adjacent line.

The invention of claim 6 is an apparatus for printing a barcode having a merchandise information code and an additional code, as well as a character string corresponding to the information contained in such barcode, on such a print medium as merchandise packaging, label or tag, said apparatus characterized by the fact that the character string's substantive character string portion, which corresponds to the merchandise information code, is printed, but the character string's additional character string portion, which corresponds to the additional code, is not printed. The merchandise information code corresponds to substantive merchandise information. The additional code does not include such substantive merchandise information.

The invention of claim 7 is an apparatus for printing a barcode having a merchandise information code and an additional code, as well as a character string corresponding to the information contained in such barcode, on such a print medium as merchandise packaging, label or tag, said apparatus comprising selection means and print means. The merchandise information code corresponds to substantive merchandise information. The additional code does not include such substantive merchandise information. Selection means allows for selection between a first mode and a second mode. In the first mode, the character string's substantive character string portion, which corresponds to the merchandise information code, is printed, but the character string's additional character string portion, which corresponds to the additional code, is not printed. In the second mode, both the substantive character string and the additional character string are printed. Print means prints on the print medium in the mode selected by selection means.

The invention of claim 8 is a merchandise attachment formed as a merchandise label or merchandise tag on which a barcode having a merchandise information code and an additional code is printed along with a character string corresponding to the information contained in such barcode, such attachment characterized by the fact that the character string's substantive character string portion, which corresponds to the merchandise information code, is printed in a print format different from the character string's additional character string portion, which corresponds to the additional code. The merchandise information code corresponds to substantive merchandise information. The additional code does not include such substantive merchandise information.

The invention of claim 9 is the merchandise attachment according to claim 8, characterized by the fact that such differing print format includes at least one of the following: 1) difference in character size; 2) difference in character font; 3) difference in whether the characters are enhanced or not; 4) difference in the type of enhancement on enhanced characters; and 5) difference in character color.

The invention of claim 10 is the merchandise attachment of either claim 8 or claim 9, characterized by the fact that the printing of such different print formats heightens the visual recognizability of the substantive character string over the visual recognizability of the additional character string.

The invention of claim 11 is a merchandise attachment formed as a merchandise label or merchandise tag on which a barcode having a merchandise information code and an additional code is printed along with a character string corresponding to the information contained in such barcode, said attachment characterized by the fact that the character string's substantive character string portion, which corresponds to the merchandise information code, is printed on a layout line different from the character string's additional character string portion, which corresponds to the additional code. The merchandise information code corresponds to substantive merchandise information. The additional code does not include such substantive merchandise information.

The invention of claim 12 is the merchandise attachment according to claim 11, characterized by the fact that the substantive character string is printed on a line adjacent to such barcode, and the additional character string is printed on a layout line different from such adjacent line.

The invention of claim 13 is a merchandise attachment formed as a merchandise label or merchandise tag on which a barcode having a merchandise information code and an additional code is printed along with a character string corresponding to the information contained in such barcode, said attachment characterized by the fact that the character string's substantive character string portion, which corresponds to the merchandise information code, is printed, but the character string's additional character string portion, which corresponds to the additional code, is not printed. The merchandise information code corresponds to substantive merchandise information. The additional code does not include such substantive merchandise information.

### A BRIEF EXPLANATION OF THE DRAWINGS

FIG. 1 is an inclined view of a price-computing scale 1 functioning as a merchandise information printing apparatus according to a first embodiment of the present invention.

FIG. 2 is a functional block diagram showing a simplified constitution of a control unit 40 of the price-computing scale 1.

FIG. 3 is a drawing showing a conventional label L0.

FIG. 4 is a drawing showing a label L1 and label L2 according to a first embodiment of the present invention.

FIG. 5 is a drawing showing a label L3, label L4, and label L5 according to the first embodiment of the present invention.

FIG. 6 is a drawing showing a label L6 according to the first embodiment of the present invention.

FIG. 7 is a drawing showing a label L7 according to a second embodiment of the present invention.

FIG. 8 is an external inclined view of an automatic weighing and pricing apparatus 2.

FIG. 9 is an external inclined view of a labeler 3.

FIG. 10 is a drawing showing an example of a typical barcode format.

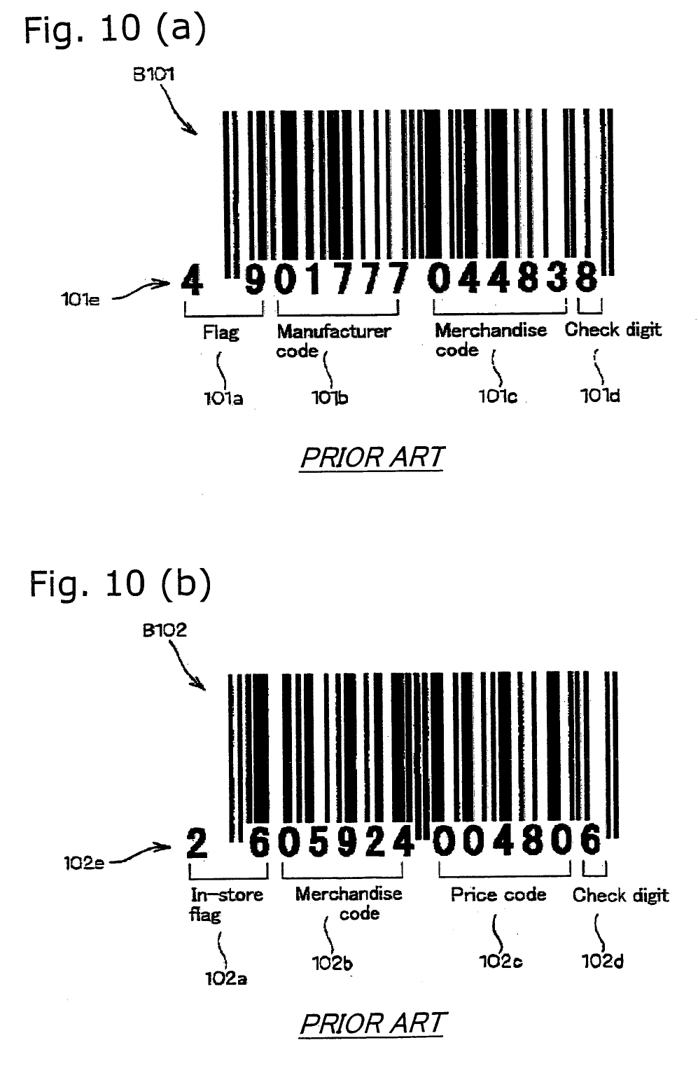

### BEST MODE FOR WORKING THE INVENTION

### FIRST EMBODIMENT

### Outline of the Apparatus

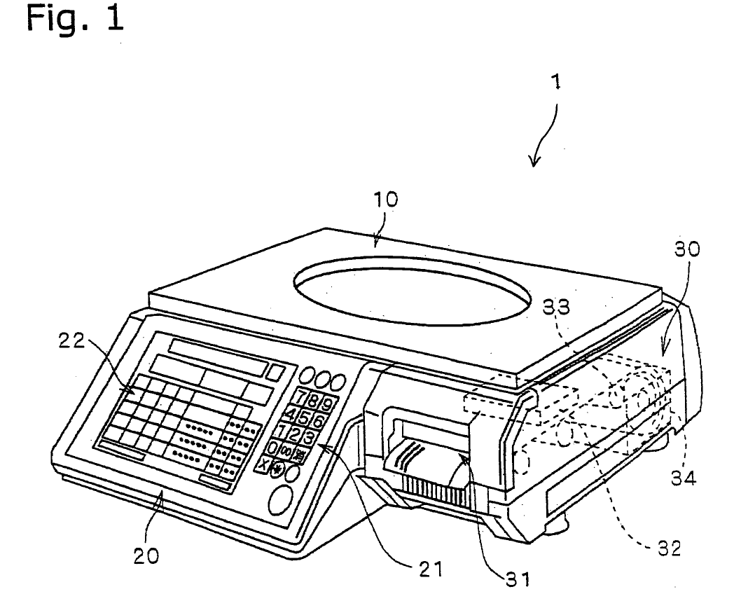

FIG. 1 is an inclined view of a price-computing scale 1 which functions as a merchandise information printing apparatus according to a first embodiment of the present invention. The price-computing scale 1 according to this embodiment is an apparatus that is frequently used at supermarkets and other retail stores; its primary functions are the weighing of merchandise, the computation of sale price as determined by the weighing results and predetermined merchandise unit price, the printing of the computed sale price and other merchandise information on a label as characters and a barcode, and the issuing of the printed label. In order to carry out these functions, the price-computing scale 1 includes primarily a weighing unit 10, an operation panel 20, and a label issuing unit 30. In addition, by carrying out the above-described functions, the price-computing scale 1 operates as a merchandise information printing apparatus that prints mainly NON-PLU barcodes.

The weighing unit 10 calculates the weight of merchandise placed on its upper surface, using a load cell that is not shown in the drawing, and then outputs the calculated weight to a control unit 40, to be described below.

The operation panel 20 comprises a ten-key pad 21 and a liquid crystal display panel 22 functioning as a touch panel. An operator, while confirming the information displayed on the display panel 22, can enter the necessary data and commands to the price-computing scale 1 using the ten-key pad 21 and the display panel 22 serving as a touch panel.

The label issuing unit 30 is contained within the price-computing scale 1; it includes a label issuing opening 31, a printing unit 32, a transport unit 33 and a label storage unit 34. The label storage unit 34 stores label layout sheets to which a plurality of blank label sheets have been attached in a continuous manner, said sheets being wound up in a roll. The transport unit 33 is constituted by a motor and a plurality of transport rolls, which are not shown in the drawing; it transports the label layout sheets stored in the label storage unit 34 to the label issuing opening 31. The printing unit 32 prints the necessary information onto the blank label sheets (strictly speaking, onto the blank label sheets that have been attached to the label layout sheets) being transported by the transport unit 33 to the label issuing opening 31. The label layout sheets transported by the transport unit 33 are sent outside the apparatus via the label issuing opening 31, so that an operator can peel off and use the printed merchandise labels from the label layout sheets sent out from the apparatus. The printing unit 32 performs single-color printing; however, the price-computing scale 1 may be an apparatus having a multicolor printing function, with a plurality of printing units 32.

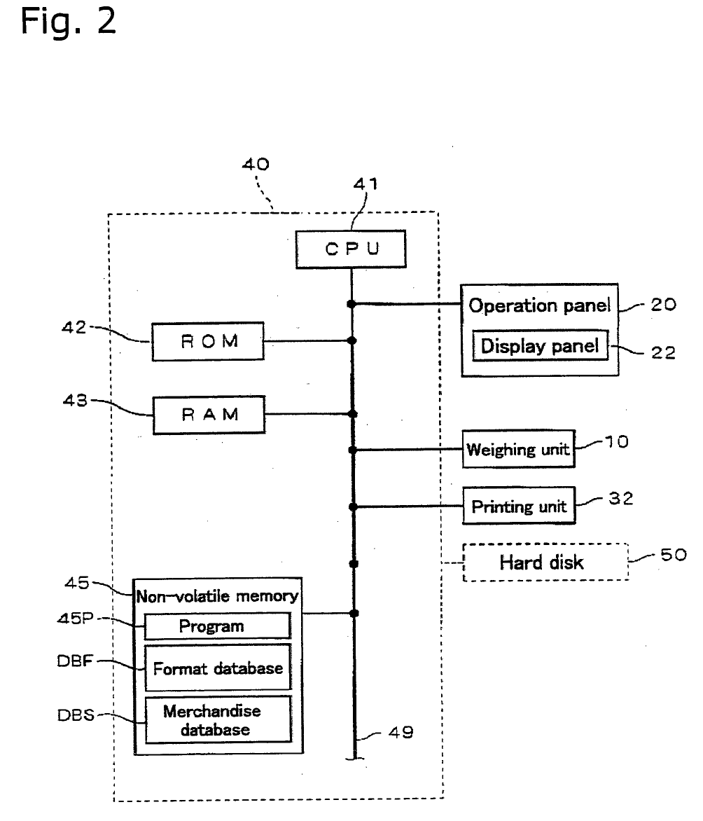

The price-computing scale 1 also includes therewithin a control unit 40 for overall control of the apparatus. FIG. 2 is a functional block diagram showing a simplified constitution of the control unit 40 of the price-computing scale 1. The control unit 40 of the price-computing scale 1 includes a CPU 41, a ROM 42, a RAM 43 and a non-volatile memory 45, which are electrically connected by a bus line 49. The weighing unit 10, the printing unit 32 and other elements are also electrically connected thereby, and these elements all operate under the control of the control unit 40. The price-computing scale 1 further includes a hard disk (HDD) 50; this HDD 50 may also be connected by the bus line.

Based on a processing program 45p provided within the non-volatile memory 45, the control unit 40 responds to input from the operation panel 20, and controls the weighing by the weighing unit 10, the calculation of the sale price based thereupon, the issuing of labels by the printing unit 32, and the display on the display panel 22 of the various processing results and processes. In addition, the non-volatile memory 45 stores a format database DBF that stores print formats for labels to be issued and a merchandise database DBS wherein merchandise name is associated with such information as that merchandise price and expiration date. Alternatively, the format database DBF and the merchandise database DBS may be stored on the HDD 50.

### Label Format

An explanation will now be given of the format (print format) of labels issued by the price-computing scale 1. In the price-computing scale 1, label formats are stored in the format database DBF. When an operator selects label format to be used in printing via the ten-key pad 21 or the display panel 22, the control unit 40 calls the selected format from the format database DBF. In accordance with this format, the printing unit 32 prints the prescribed information on the blank label sheets.

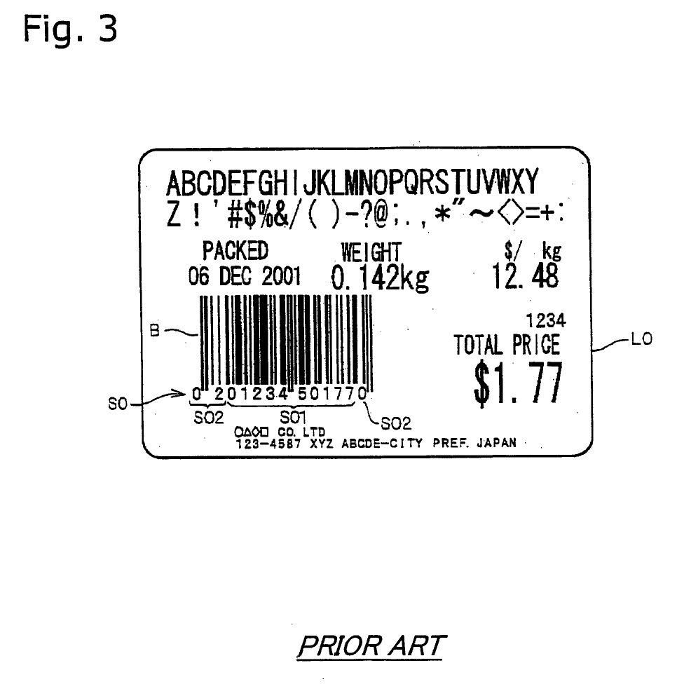

FIG. 3 is a drawing showing a conventional label L0, which is presented for purposes of comparison with the labels according to the embodiments described hereinbelow. On the conventional label L0, barcode B comprising merchandise information, and character string S0 showing the same information as the information contained in this barcode B are printed in addition to such merchandise information as merchandise name, processing date, merchandise weight, unit price and sale price. When this barcode B is printed in NON-PLU form, the character string S0, as described above, comprises a substantive character string S01, which is made up of a merchandise code and a price code, which correspond to the substantive merchandise information of type and sale price of merchandise, and the remaining character information, namely, additional character string S02, which is made up of a flag and check digit. In the conventional label L0, the substantive character string S0 and additional character string S02 are printed using the same print format; thus there is the problem that it is difficult to tell at a glance what part is the substantive character string S01.

An explanation will now be given, using examples of printed labels, about specific forms of label format contained in the price-computing scale 1 for the purposes of solving the above-described problems of the conventional label L0.

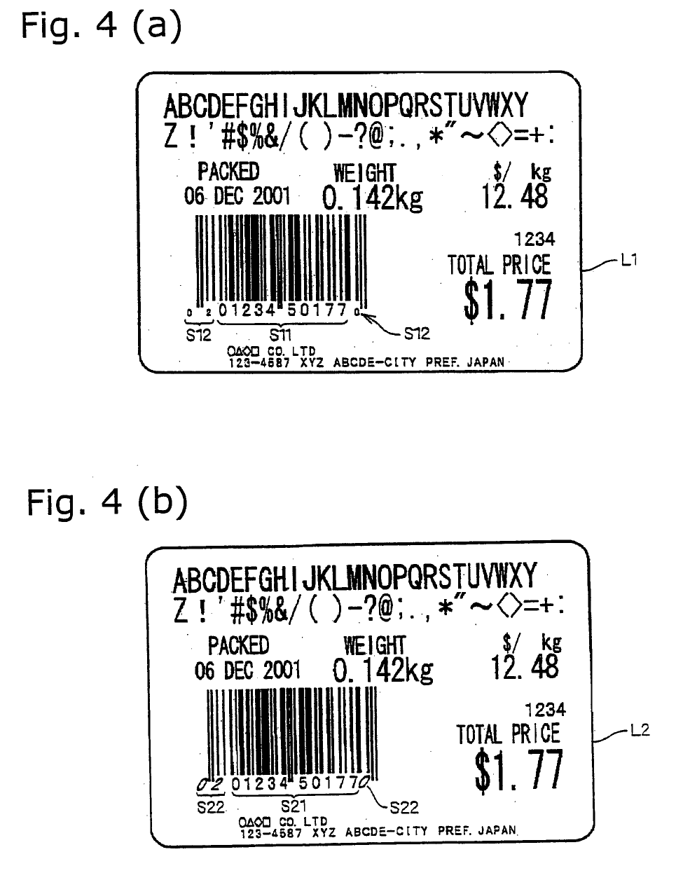

FIG. 4 is a drawing showing a label L1 and a label L2 according to the present embodiment. The print content of the label L1 and of the label L2 is the same as that of the conventional label L0 shown in FIG. 3, but the form of the printed characters of the additional character string (i.e., the form of the visible characters) is different from that of the conventional label L0.

The format of the label L1 shown in FIG. 4(a) is different from that of the conventional label L0 in that an additional character string S12 is printed in a point size smaller than that of a substantive character string S11. The difference in point size makes it easy for an operator to recognize intuitively that there is a difference in importance between the two types of printed content. Thus the operator can easily distinguish visually between the substantive character string S11 and the additional character string S12.

The format of the label L2 shown in FIG. 4(b) is different from that of the conventional label L0 in that an additional character string S22 is printed in an italic font. The difference in font makes it easy for an operator to recognize intuitively that there is a difference in importance between the two types of printed content. Thus the operator can easily distinguish visually between the substantive character string S21 and the additional character string S22.

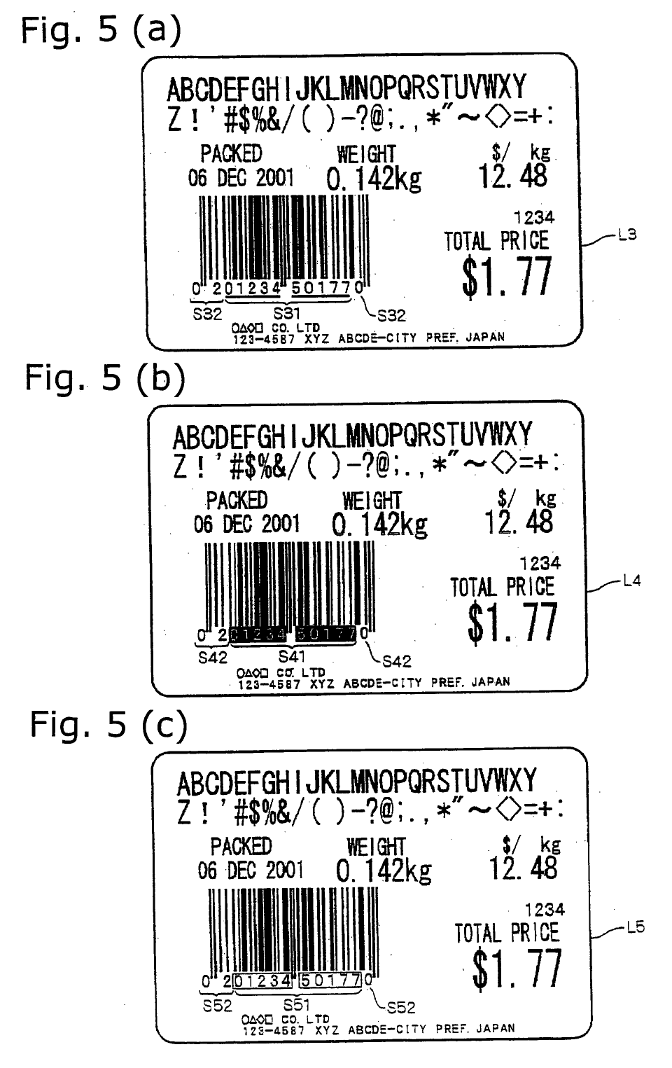

FIG. 5 is a drawing showing a label L3, label L4 and label L5 according to the present embodiment. The printed content of the label L3, label L4 and label L5, respectively, is the same as the printed content of the conventional label L0 shown in FIG. 3; however, the print format of the additional character string is different in all cases from that of the conventional label L0.

The format of the label L3 shown in FIG. 5(a) is different from that of the conventional label L0 in that only the substantive character string S31 is underlined. The format of the label L4 shown in FIG. 5(b) is different from that of the conventional label L0 in that only the substantive character string S41 is printed as white on black (reverse printing). The format of the label L5 shown in FIG. 5(c) is different from that of the conventional label L0 in that only the substantive character string S51 is printed outlined in a box.

As shown in FIG. 5, by underlining, reverse printing, outlining in a box or otherwise adding some enhancement to characters to be printed, it becomes easy for an operator to recognize intuitively that the portion so printed contains the more important information. Therefore, an operator can easily distinguish visually between the substantive character strings S31, S41, and S51, and the respective additional character strings S32, S42, and S52. As long as the same purpose is achieved, a label format such that the substantive character string is easily recognized visually can be used having enhanced characters different from those described above.

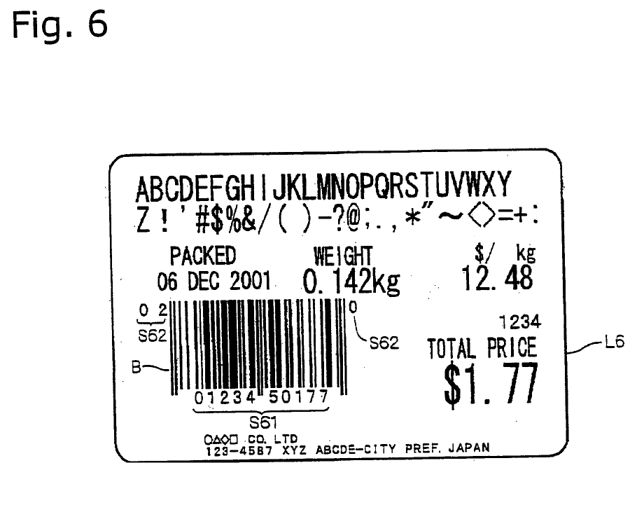

FIG. 6 is a drawing showing a label L6 according to the present embodiment. The print content of the label L6 is the same as that of the conventional label L0 shown in FIG. 3; however, the format of the label L6 is characterized by the fact that the additional character string S62 is disposed on a layout line different from that of the substantive character string S61. Specifically, this is different from the conventional label L0 in that the additional character string S62 is positioned at the upper end of the barcode B. In other words, in FIG. 6, because only the substantive character string S61 is positioned directly below the barcode B, it is recognizable that the substantive character string S61 reflects the information contained in the barcode S61. Thus, during key input, the problem of the additional character string S62 being mistakenly identified as information to be input can be avoided.

It should be noted that the print position of the additional character string S62 is not limited to the upper end of the barcode B, as shown in FIG. 6, provided that such position is one that prevents such additional character string S62 from being mistakenly identified as part of the substantive character string S61. However, it is preferable to avoid printing the additional character string S62 directly to the side of and directly near the barcode B, as it is necessary to maintain blank space (quiet zone) so that when a scanner is to read the barcode B, it is able to recognize that there is a barcode present.

In cases where the price-computing scale 1 has a multicolor printing function, a format may be used such that the substantive character string and the additional character string are printed in different colors. Or a format may be used that is a combination of a format described above and printing in a different color.

As described above, in the price-computing scale 1 according to the present embodiment, when labels are printed, using different print formats for the substantive character string and the additional character string, or else printing on different layout lines, results in a difference between the substantive and additional character strings that makes the substantive character string more visibly recognizable than the additional character string. Thus the visual recognizability of the substantive character string on the label is increased. The use of labels having substantive character strings with high visual recognizability will increase visual recognizability during key input at a cash register, meaning that key input mistakes arising from mis-recognition can be avoided.

### SECOND EMBODIMENT

For the first embodiment, an explanation was made for a format for heightening the visible recognizability of the substantive character string by distinguishing the additional character string from the substantive character string; however, the mis-recognition of the substantive character string during key input at a cash register can also be avoided by not printing the additional character string, which is the cause of such mis-recognition.

However, if the additional character string is entirely omitted, people will no longer be able to directly acquire from a label the information in the flag and check digit, which is contained in the portion of the barcode that corresponds to the additional character string. During normal operations this is not a problem; however, during, for example, cash register maintenance, when the scanner is being checked for whether or not it is properly reading barcodes, it is desirable to be able to visually confirm the check digit contained in the additional character string.

Thus the price-computing scale according to this embodiment allows the selection of whether or not to print the additional character string, so that the additional character string is printed out only when needed.

Because the constitution of the price-computing scale according to the present embodiment has essentially the same constitution as the price-computing scale 1 according to the first embodiment, the same indicators will be used in the explanation. However, a sub-routine has been added to the processing program 45p, for the purpose of allowing a selection between an additional character string print mode and an additional character string non-print mode.

During printing, an operator gives instructions using the ten-key pad 21 or the display panel 22 for the selection of either the additional character string print mode and additional character string non-print mode. When the additional character string nonprint mode has been selected, a label format such that the additional character string is not printed is selected from the format database DBF and supplied for printing.

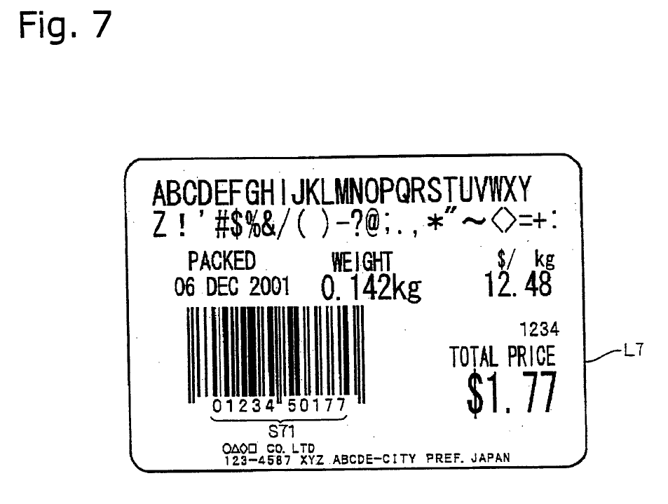

FIG. 7 is a drawing showing a label L7 according to the present embodiment. The label L7 is a print example in a case where the additional character string non-print mode has been selected. Because only the substantive character string S71 appears directly below the barcode B, during key input, only the substantive character string S71 is viewed and inputted.

In cases where the additional character string print mode is selected because of a need to refer to the additional character string, printing may be carried out in the format of the conventional label L0 as shown in FIG. 3; however, it is preferable for the printing to be in a format where the substantive character string and the additional character string are easily distinguishable, as with a label according to the first embodiment. For example, in cases where the additional character string print mode in the same format as that of the label L7 has been selected, printing will take the form as shown in FIG. 4 or FIG. 6.

Alternatively, in the additional character string non-print mode, a selection may be offered of a format such that the additional character string has been excluded from the label print example shown in FIG. 5, where the substantive character string has been printed in enhanced characters.

As explained above, in the price-computing scale according to the present embodiment, the additional character string is printed only when needed and is not printed when not needed; thus, during normal key input, an operator will not mistake an additional character string as part of the substantive character string; increasing the visual recognizability of the substantive character string during key input will lead to the avoidance of input mistakes due to mis-recognition.

### Variations

In the above-described embodiment, the character font for the additional character string was changed to italic; however, italic or bold fonts may be used for the substantive character string, or else a font may be used that is different from the font for the additional character string, thereby identifying which is the substantive character string and which is the additional character string.

While it is desirable to heighten the visual recognizability of the substantive character string (that is, to make the substantive character string conspicuous), even just, for example, putting the substantive character string and the additional character string on different character strings would prove more effective than the conventional layout at least for the purposes of being able to easily identify what is the substantive character string.

If there is extra print space, a label format may be used such that, for example, the point size of the additional character string is not changed, but the substantive character string is printed in a point size larger than that of the additional character string.

Alternatively, a combination of a plurality of the various print formats described above may also be used.

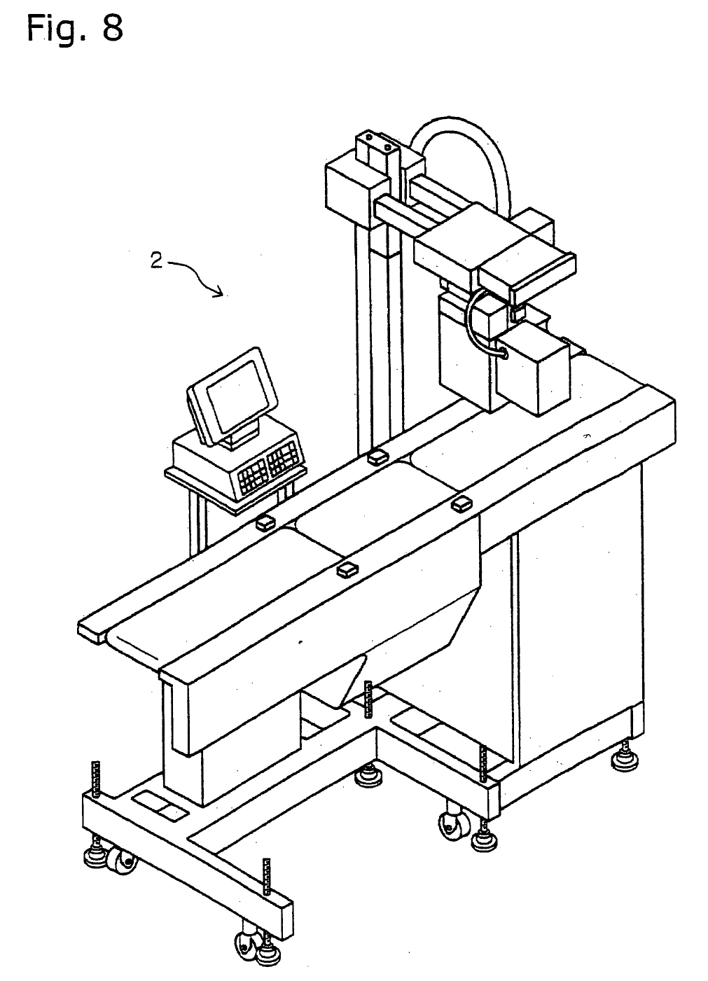

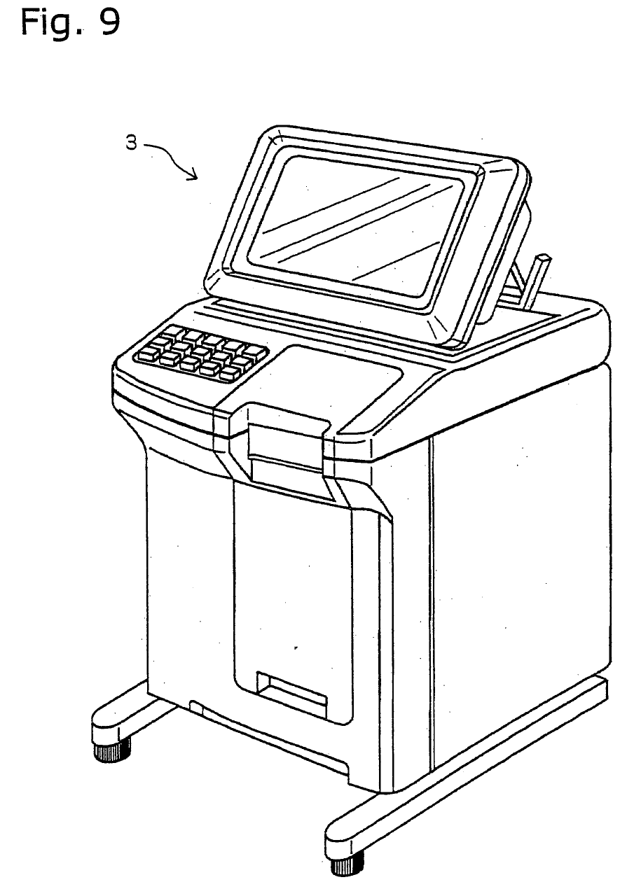

The form of the merchandise information printing apparatus according to the present invention is not limited to a price-computing apparatus as described in the above embodiments. For example, an automatic weighing and pricing apparatus 2, as shown in FIG. 8, which continuously weighs and prices merchandise, or a labeler 3, as shown in FIG. 9, which does not have a weighing function, may also be used to embody the present invention; such apparatuses are capable of issuing labels with the above-described identifiability.

In addition, the printed matter is not limited to labels; any printed matter on which barcodes may be printed may be used to embody the present invention. For example, merchandise packaging and tags attached to merchandise and other merchandise attachments may be used as the media for the printing of the present invention.

### Industrial Applicability

The inventions of claims 1 through 13 are used to increase the visual recognizability of substantive character strings during key input of merchandise sale information when a barcode cannot be read.

In particular, the inventions according to claim 2 and claim 9 improve visual recognizability using a method that utilizes available print formats.

The inventions according to claim 4 through claim 6, and claim 11 through claim 13, are effective in the avoidance of mistaking the substantive character string and the additional character string.

The invention according to claim 7 allows the additional character string to be printed only when it is necessary to refer thereto.

1. An apparatus for printing a barcode having a merchandise information code corresponding to substantive merchandise information and an additional code that does not include such substantive merchandise information, as well as a character string corresponding to the information contained in the barcode, on a print medium such as merchandise packaging or label or tag, wherein:
said character string's substantive character string portion, which corresponds to said merchandise information code, and said character string's additional character string portion, which corresponds to said additional code, are printed in different print formats.

2. An apparatus according to claim 1, wherein:
said different print formats include at least one of the following differences:
1) difference in character size;
2) difference in character font;
3) difference in whether the characters are enhanced or not;
4) difference in the type of enhancement on enhanced characters; and
5) difference in character color.

3. An apparatus according to either claim 1 or claim 2, wherein printing using such differing print formats heighten the visual recognizability of said substantive character string portion over the visual recognizability of said additional character string portion.

4. An apparatus for printing barcodes having a merchandise information code corresponding to substantive merchandise information, and an additional code that does not include said substantive merchandise information, as well as a character string corresponding to the information contained in said barcode, on such a print medium as merchandise packaging, label or tag, wherein:
said character string's substantive character string portion, which corresponds to said merchandise information code, is printed on a layout line different from said character string's additional character string portion, which corresponds to said additional code.

5. An apparatus according to claim 4, wherein:
said substantive character string portion is printed on a line adjacent to such barcode, and
said additional character string portion is printed on a layout line different from said adjacent line.

6. An apparatus for printing a barcode having a merchandise information code corresponding to substantive merchandise information and an additional code that does not include said substantive merchandise information, as well as a character string corresponding to the information contained in said barcode, on such a print medium as merchandise packaging, label or tag, wherein:
said character string's substantive character string portion, which corresponds to said merchandise information code, is printed, but said character string's additional character string portion, which corresponds to said additional code, is not printed.

7. An apparatus for printing a barcode having a merchandise information code corresponding to said substantive merchandise information and an additional code that does not include such substantive merchandise information, as well as a character string corresponding to the information contained in said barcode, on such a print medium as merchandise packaging, label or tag,
said merchandise information printing apparatus comprising:
selection means allowing for selection of either
a first mode where said character string's substantive character string portion, which corresponds to said merchandise information code, is printed, but said character string's additional character string portion, which corresponds to said additional code, is not printed, or
a second mode where both said substantive character string and said additional character string are printed; and
print means for printing on said medium in the mode selected by said selection means.

8. A merchandise attachment formed as a merchandise label or merchandise tag on which a barcode having a merchandise information code corresponding to substantive merchandise information and an additional code that does not include said substantive merchandise information is printed along with a character string corresponding to the information contained in said barcode, wherein:
said character string's substantive character string portion, which corresponds to said merchandise information code, is printed in a print format different from said character string's additional character string portion, which corresponds to said additional code.

9. A merchandise attachment according to claim 8, wherein:
said differing print format includes at least one of the following:
1) difference in character size;
2) difference in character font;
3) difference in whether the characters are enhanced or not;
4) difference in the type of enhancement on enhanced characters; and
5) difference in character color.

10. A merchandise attachment according to either claim 8 or claim 9, wherein:
the printing in said different print formats heightens the visual recognizability of said substantive character string portion over the visual recognizability of said additional character string portion.

11. A merchandise attachment formed as a merchandise label or merchandise tag on which a barcode having a merchandise information code corresponding to substantive merchandise information and an additional code that does not include said substantive merchandise information is printed along with a character string corresponding to the information contained in said barcode, wherein:
said character string's substantive character string portion, which corresponds to said merchandise information code, is printed on a layout line different from said character string's additional character string portion, which corresponds to said additional code.

12. A merchandise attachment according to claim 11, wherein:
said substantive character string portion is printed on a line adjacent to said barcode, and
said additional character string portion is printed on a layout line different from said adjacent line.

13. A merchandise attachment formed as a merchandise label or merchandise tag on which a barcode having a merchandise information code corresponding to substantive merchandise information and an additional code that does not include such substantive merchandise information is printed along with a character string corresponding to the information contained in such barcode, wherein:
said character string's substantive character string portion, which corresponds to said merchandise information code, is printed, but said character string's additional character string portion, which corresponds to said additional code, is not printed.
